(19) United States
(12) Patent Application Publication
(10) Pub. No.: US 2020/0363287 A1
(43) Pub. Date: Nov. 19, 2020

(54) DAMAGE DIAGNOSING DEVICE, DAMAGE DIAGNOSING METHOD, AND RECORDING MEDIUM HAVING DAMAGE DIAGNOSING PROGRAM STORED THEREON

(71) Applicant: NEC CORPORATION, Tokyo (JP)

(72) Inventors: Shohei KINOSHITA, Tokyo (JP); Shigeru KASAI, Tokyo (JP); Yu KIYOKAWA, Tokyo (JP)

(73) Assignee: NEC CORPORATION, Tokyo (JP)

(21) Appl. No.: 16/763,798

(22) PCT Filed: Nov. 14, 2018
(86) PCT No.: PCT/JP2018/042103

§ 371 Date: May 13, 2020

(30) Foreign Application Priority Data
Nov. 16, 2017 (JP) 2017-220893

(51) Int. Cl. G01M 5/00; G01M 7/02

(52) U.S. Cl. CPC G01M 5/0033; G01M 5/0008; G01M 7/025; G01M 7/022; G01M 5/0066

(57) ABSTRACT

A damage diagnosing device includes: a generating unit which generates second vibration characteristic information including a characteristic value of an increase characteristic opposite to an amplitude of oscillation exhibited by first vibration characteristic information, relating to a structure including a supporting portion and a supported portion supported at a support point by the supporting portion; a calculating unit which calculates a degree that values indicated by the first vibration characteristic information and the second vibration characteristic information have changed from reference values relating to the first vibration characteristic information and the second vibration characteristic information as a result of damage that has occurred in the structure; and a diagnosing unit which diagnoses the damage on the basis of the degree of change, to more accurately diagnose damage that has occurred in a structure having a supporting portion and a supported portion supported at a support point by the supporting portion.

### TECHNICAL FIELD

The invention of the present application relates to a technique of diagnosing damage occurring in a structure, such as a bridge, including a supporting portion and a supported portion supported at a support point by the supporting portion.

### BACKGROUND ART

Expectation has been rising for a technique of more accurately diagnosing damage occurring in a structure, in such a way that occurrence of an accident resulting from damage occurring in various aging structures (e.g. a bridge or an architectural structure such as a building) can be prevented.

As a technique related to such a technique, PTL 1 discloses a structure abnormality sensing device that senses an abnormality of a structure. This device stores a model that predicts, based on a first inspection value acquired at a first inspection position, a second inspection value acquired at a second inspection position being a position where vibration intensity during predetermined vibration at a natural frequency of the structure becomes about the same as that at the first inspection position. This device senses an abnormality of the structure by evaluating a level of adaptation to the model, in relation to the first inspection value and the second inspection value each acquired at a certain time.

PTL 2 discloses a method of evaluating a change amount of a railway bridge natural frequency, being used when a crack occurring in a lower surface of a main girder of a concrete railway bridge is sensed from a change in natural frequency of the concrete railway bridge. This method measures a vibration waveform of the main girder of the concrete railway bridge. This method generates a mode waveform by performing, for the measured vibration waveform, Fourier transform processing, peak-vibration-number extraction processing, and band-pass-filter processing. This method calculates an envelope of the generated mode waveform, and generates, based on the calculated envelope, a standard mode waveform in such a way that an amplitude is always constant. Then, this method evaluates, based on the generated standard mode waveform, a change amount of the railway bridge natural frequency by use of a model permitting a time change for an autoregressive coefficient matrix of a multivariable autoregressive model.

PTL 3 discloses a device that evaluates a soundness level relating to a guard fence support rod where a support condition (deterioration, damage, a burying condition, or the like) of a support rod base part has changed from that at a design stage after a long period has passed from installation. This device acquires a vibration mode by performing vibration mode analysis for a guard-fence-support-rod model. This device designates, as a reference mode, a vibration mode of any degree among vibration modes. When vibration is applied, at a predetermined position, to a guard fence support rod to be an evaluation target, this device acquires, from sensors disposed at a plurality of positions in the guard fence support rod, amplitude values at the plurality of positions. This device performs curve-fitting processing by acquiring an actual measurement mode, based on the amplitude value, and calculating a position where a square sum of a difference between each amplitude value constituting the actual measurement mode and an amplitude value included in the reference mode becomes minimum. Then, this device calculates a model assurance criteria (MAC) value of the reference mode and the actual measurement mode, and evaluates a soundness level relating to the guard fence support rod, based on the calculated MAC value.

PTL 4 discloses a system that monitors displacement, strain, or the like inside a structure. This system includes, for diagnosis of damage in the structure, a plurality of vibration response detection sensors placed at two points across a monitoring target part of the structure, and a referential response detection sensor placed at a referential point. This system acquires, based on vibration measurement data acquired by the sensors, a relative mode shape and a referential mode shape of an n-order mode (n is an integer satisfying 1≤n≤N), and a natural frequency of an n-order mode, in each of vibration modes of which the number of natural vibrations is N (N is any integer). Then, this system calculates an evaluation value derived from the acquired values, and evaluates a damage index relating to the structure, based on a current evaluation value and an evaluation value in a sound state.

### CITATION LIST

### Patent Literature

[PTL 1] International Publication No. WO2017/064854

[PTL 2] Japanese Unexamined Patent Application Publication No. 2016-194442

[PTL 3] Japanese Unexamined Patent Application Publication No. 2015-036661

[PTL 4] Japanese Unexamined Patent Application Publication No. 2008-134182

### SUMMARY OF INVENTION

### Technical Problem

A problem when diagnosing damage in a structure, such as a bridge, including a supporting portion and a supported portion supported at a support point by the supporting portion is considered.

FIG. 6 is a diagram exemplifying a configuration of a bridge 20 being a target for diagnosing damage. The bridge 20 includes supporting portions 21 and 22 and a supported portion 23. The supporting portions 21 and 22 are bridge piers in the bridge 20, and the supported portion 23 is a bridge beam in the bridge 20. The supported portion 23 is supported by the supporting portion 21 at a support point 210, and supported by the supporting portion 22 at a support point 220.

As exemplified in FIG. 6, nine sensors 30-1 to 30-9 are laid out on the supported portion 23 at predetermined intervals in an X-axis direction. The sensors 30-1 to 30-9 are sensors being capable of collecting data (such as an amplitude of vibration) relating to vibration of the bridge 20, occurring due to crossing of a vehicle or the like over the bridge 20.

The bridge 20 has a natural vibration characteristic (natural vibration). FIG. 7 is a diagram exemplifying a mode shape being one piece (parameter) of information representing a vibration characteristic of the bridge 20 when no damage occurs in the bridge 20. In the present application, “no damage occurs” hereinafter also includes a fact that a negligible level of damage (i.e., a level of damage that does not become a problem) occurs. The mode shape exemplified in FIG. 7 is represented by a curve connecting values indicating an amplitude of vibration collected by the sensors 30-1 to 30-9, on a horizontal axis indicating a spatial position (an X-coordinate illustrated in FIG. 6), and on a vertical axis indicating an amplitude of vibration. The mode shape exemplified in FIG. 7 is normalized in such a way that a maximum value of an amplitude becomes “1”. It is known that an amplitude characteristic indicated by a mode shape of a structure, such as a bridge, including a supporting portion and a supported portion supported at a support point by the supporting portion generally becomes small in amplitude value in the vicinity of a support point (a position equivalent to a node), and becomes great in amplitude value in the vicinity of a middle part between two support points (a position equivalent to an antinode), as illustrated in FIG. 7. The mode shape exemplified in FIG. 7 can be represented as a characteristic vector 4:1:1 indicated in Equation (1).

characteristic vector Φ=^{t}(r₁ e¹, r₂ e², . . . , rₙ eⁿ) (Equation 1)

In Equation 1, rⱼ and θⱼ (j is an integer of one of 1 to n) represent an amplitude and a phase acquired by the sensor 30-j, in order. n is an integer indicating the number of sensors placed on the bridge 20, and is “9” in the example illustrated in FIGS. 6 and 7. eⁱ represents a complex number notation, and t is a sign representing a transposition of a vector.

When damage occurs in the bridge 20, a mode shape of the bridge 20 changes, and therefore, a fact that damage occurs in the bridge 20 can be detected by detecting the change of the mode shape. FIG. 8 is a diagram exemplifying a change of an amplitude indicated by a mode shape when damage occurs in the vicinity of a middle part of the supported portion 23 of the bridge 20. In this case, damage occurs in the bridge 20 near a part where the sensor 30-5 is placed, and as a consequence, an amplitude of vibration acquired by the sensor 30-5 is twice an amplitude indicated by the mode shape exemplified in FIG. 7. Amplitudes acquired by the sensors 30-1 to 30-4 and the sensors 30-6 to 30-9 being placed at positions where no damage occurs have almost no difference as compared with the amplitude indicated by the mode shape exemplified in FIG. 7. In this case, in relation to the amplitude acquired by the sensor 30-5, a change amount from an amplitude (reference value) indicated by a mode shape in which no damage occurs is great, and therefore, it is easy to detect that damage occurs in the bridge 20.

FIG. 9 is a diagram exemplifying a change of an amplitude indicated by a mode shape when damage occurs in the vicinity of the support point 210 of the bridge 20. In this case, damage occurs in the bridge 20 near a part where the sensor 30-1 is placed, and as a consequence, an amplitude of vibration acquired by the sensor 30-1 is twice the amplitude indicated by the mode shape exemplified in FIG. 7, as in the case of the example illustrated in FIG. 8. However, in this case, a change amount from the reference value of the mode shape near a part where damage occurs is extremely small as compared with the case of the example illustrated in FIG. 8, and therefore, there is fear that changing of the mode shape is overlooked. Specifically, the present inventor has found out that accurately diagnosing damage occurring in a structure such as a bridge even when damage occurs in the vicinity of a support point where an amplitude indicated by a vibration characteristic (mode shape) is small in the structure is a problem. PTLs 1 to 4 do not refer to this problem. A main object of the invention of the present application is to provide a damage diagnosing device and the like that solve this problem.

### Solution to Problem

A damage diagnosing device according to one aspect of the invention of the present application includes: a generating means for generating second vibration characteristic information including a characteristic value having an increase characteristic opposite to an amplitude indicated by first vibration characteristic information, relating to a structure including a supporting portion and a supported portion supported at a support point by the supporting portion; a calculating means for calculating a degree that values indicated by the first and second vibration characteristic information change from reference values relating to the first and second vibration characteristic information as a result of damage occurring in the structure; and a diagnosing means for diagnosing the damage, based on the degree of change.

In another viewpoint of achieving the object described above, a damage diagnosing method according to one aspect of the invention of the present application includes: by an information processing device, generating second vibration characteristic information including a characteristic value having an increase characteristic opposite to an amplitude indicated by first vibration characteristic information, relating to a structure including a supporting portion and a supported portion supported at a support point by the supporting portion; calculating a degree that values indicated by the first and second vibration characteristic information change from reference values relating to the first and second vibration characteristic information as a result of damage occurring in the structure; and diagnosing the damage, based on the degree of change.

In still another viewpoint of achieving the object described above, a damage diagnosing program according to one aspect of the invention of the present application is a program that causes a computer to execute: generating processing of generating second vibration characteristic information including a characteristic value having an increase characteristic opposite to an amplitude indicated by first vibration characteristic information, relating to a structure including a supporting portion and a supported portion supported at a support point by the supporting portion; calculating processing of calculating a degree that values indicated by the first and second vibration characteristic information change from reference values relating to the first and second vibration characteristic information as a result of damage occurring in the structure; and diagnosing processing of diagnosing the damage, based on the degree of change.

Furthermore, the invention of the present application is also achievable by a computer-readable non-volatile recording medium having the damage diagnosing program (computer program) stored thereon.

### Advantageous Effects of Invention

The invention of the present application enables more accurately diagnosing damage occurring in a structure, such as a bridge, including a supporting portion and a supported portion supported at a support point by the supporting portion.

### BRIEF DESCRIPTION OF DRAWINGS

FIG. 1 is a block diagram conceptually illustrating a configuration of a damage diagnosing system 1 according to a first example embodiment of the invention of the present application.

FIG. 2 is a diagram illustrating a change of an inverse number of an amplitude indicated by an inverse mode shape generated by a damage diagnosing device 10 according to the first example embodiment of the invention of the present application when damage occurs in the vicinity of a support point 210 of a bridge 20.

FIG. 3 is a flowchart illustrating an operation of the damage diagnosing device 10 according to the first example embodiment of the invention of the present application.

FIG. 4 is a block diagram conceptually illustrating a configuration of a damage diagnosing device 40 according to a second example embodiment of the invention of the present application.

FIG. 5 is a block diagram illustrating a configuration of an information processing device 900 being capable of executing the damage diagnosing device according to each example embodiment of the invention of the present application.

FIG. 6 is a diagram exemplifying a configuration of a bridge 20 being a target for diagnosing damage.

FIG. 7 is a diagram exemplifying a mode shape (amplitude characteristic) when no damage occurs in the bridge 20.

FIG. 8 is a diagram exemplifying a change of an amplitude indicated by a mode shape (amplitude characteristic) when damage occurs in the vicinity of a middle part of a supported portion of the bridge 20.

FIG. 9 is a diagram exemplifying a change of an amplitude indicated by a mode shape (amplitude characteristic) when damage occurs in the vicinity of the support point 210 of the bridge 20.

### EXAMPLE EMBODIMENT

Hereinafter, example embodiments of the invention of the present application will be described in detail with reference to the drawings.

### First Example Embodiment

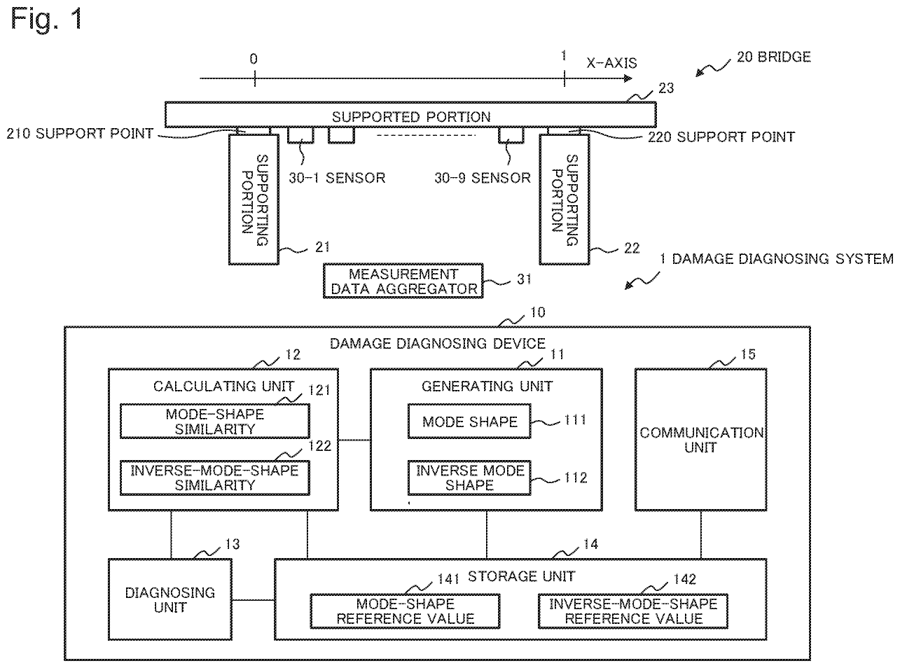

FIG. 1 is a block diagram conceptually illustrating a configuration of a damage diagnosing system 1 according to a first example embodiment of the invention of the present application. The damage diagnosing system 1 broadly includes a damage diagnosing device 10, a bridge 20, sensors 30-1 to 30-9, and a measurement data aggregator 31. The damage diagnosing device 10 is a device that diagnoses damage occurring in the bridge 20. As described above, the damage diagnosing device 10 diagnoses damage occurring in the bridge 20, by detecting that a mode shape (first vibration characteristic information) of the bridge 20 changes from a reference value (value when no damage occurs) due to occurrence of damage in the bridge 20.

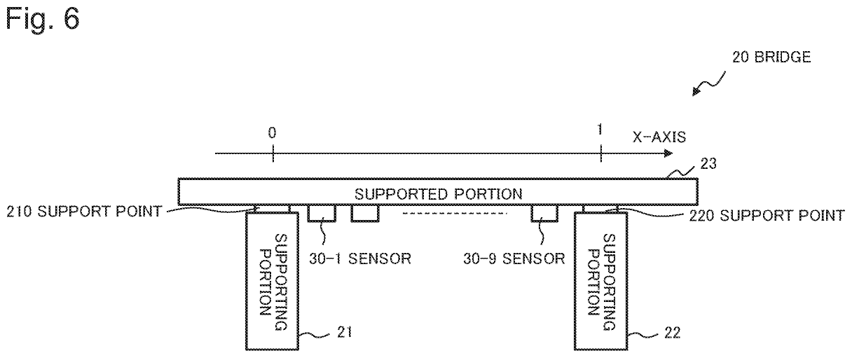

A configuration of the bridge 20 according to the present example embodiment is as described above with regard to FIG. 6. Specifically, the bridge 20 includes supporting portions 21 and 22 and a supported portion 23. The supported portion 23 is supported by the supporting portion 21 at a support point 210, and supported by the supporting portion 22 at a support point 220.

As exemplified in FIG. 1, nine sensors 30-1 to 30-9 are laid out at observation points on the supported portion 23 at predetermined intervals in an X-axis direction. An X-axis is, for example, a longitudinal direction of the bridge 20, and is a direction of arrangement of the two supporting portions 21 and 22. The sensors 30-1 to 30-9 are sensors being capable of collecting data (an amplitude or the like of vibration) relating to vibration of the bridge 20 occurring due to crossing of a vehicle or the like over the bridge 20. Note that the number of the sensors according to the present example embodiment is not limited to nine. The measurement data aggregator 31 acquires, at a predetermined timing, measurement data relating to vibration of the bridge 20 collected by the sensors 30-1 to 30-9, by performing, for example, wireless communication with the sensors 30-1 to 30-9. The measurement data aggregator 31 transmits the acquired measurement data to the damage diagnosing device 10 at a predetermined timing by, for example, wireless communication.

The damage diagnosing device 10 includes a generating unit 11, a calculating unit 12, a diagnosing unit 13, a storage unit 14, and a communication unit 15.

The communication unit 15 receives measurement data relating to vibration of the bridge 20 collected by the sensors 30-1 to 30-9, by performing, for example, wireless communication with the measurement data aggregator 31.

The storage unit 14 is a storage device such as an electronic memory or a magnetic disk. The storage unit 14 stores the measurement data received by the communication unit 15 and relating to vibration of the bridge 20 collected by the sensors 30-1 to 30-9. The storage unit 14 also stores information (data) generated by the generating unit 11, the calculating unit 12, and the diagnosing unit 13 that will be described later.

The generating unit 11 includes a function of identifying natural vibration and generating (extracting) a mode shape (vibration characteristic), in relation to the bridge 20. Specifically, the generating unit 11 calculates a frequency spectrum by performing frequency conversion of time history waveforms (waveforms representing vibration varying with elapse of time) representing vibration at at least one or more specific positions in the bridge 20. The specific positions may be positions other than three positions including the support point 210, the support point 220, and a middle position between the support point 210 and the support point 220. The generating unit 11 identifies, as a frequency of natural vibration, a peak frequency in a frequency spectrum at the specific position.

The generating unit 11 calculates, by performing frequency conversion of time history waveforms representing vibration at different positions (positions where the sensors 30-1 to 30-9 are placed) in the bridge 20 in the same period, frequency spectrums at the positions. The generating unit 11 generates a mode shape by extracting information representing an amplitude and a phase at the frequency (peak frequency) of the above-described natural vibration from the frequency spectrums at the positions.

The above-described method of generating a mode shape by identifying natural vibration by the generating unit 11 is one example of a method presented by an existing technique, and a method of generating a mode shape by identifying natural vibration by the generating unit 11 is not limited to the above-described method.

The generating unit 11 generates, as a reference value 141 of a mode shape, a characteristic vector Φ representing a mode shape of the bridge 20 when no damage occurs in the bridge 20, based on measurement data collected by the sensors 30-1 to 30-9, for example, as indicated in Equation 1 described above. The generating unit 11 stores the generated mode-shape reference value 141 in the storage unit 14.

In the present example embodiment, an index referred to as an inverse mode shape (second vibration characteristic information) is defined for a mode shape. It is assumed that a characteristic vector Φ⁻¹ representing an inverse mode shape according to the present example embodiment is represented, for example, as indicated by Equation 2.

$$characteristic vector {Φ}^{- 1} {\text{?}}^{t} ( \frac{1}{\text{?}} \text{?} , \frac{1}{\text{?}} {e}^{\text{?}} , … , \frac{1}{{r}_{\text{?}}} {e}^{\text{?}} ) \\ \text{?} \text{indicates text missing or illegible when filed} \qquad ( Equation 2 )$$

In Equation 2, rⱼ and θⱼ (j is an integer of one of 1 to n) represent an amplitude and a phase acquired by the sensor 30-j in order, as in Equation 1. n is an integer indicating the number of sensors placed on the bridge 20, and is “9” in the example illustrated in FIG. 1. eⁱ represents a complex number notation, and t is a sign representing a transposition of a vector.

An inverse mode shape is an index in which an amplitude in a mode shape is replaced by an inverse number thereof, as indicated by Equations 1 and 2. Therefore, a characteristic value (i.e., an inverse number of an amplitude) indicated by an inverse mode shape has an increase characteristic (a characteristic that becomes great as an amplitude indicated by a mode shape becomes small) opposite to an amplitude indicated by a mode shape.

The generating unit 11 generates, as a reference value 142 of an inverse mode shape, the characteristic vector Φ⁻¹ representing an inverse mode shape of the bridge 20 when no damage occurs in the bridge 20, based on measurement data collected by the sensors 30-1 to 30-9. The generating unit 11 stores the generated inverse-mode-shape reference value 142 in the storage unit 14.

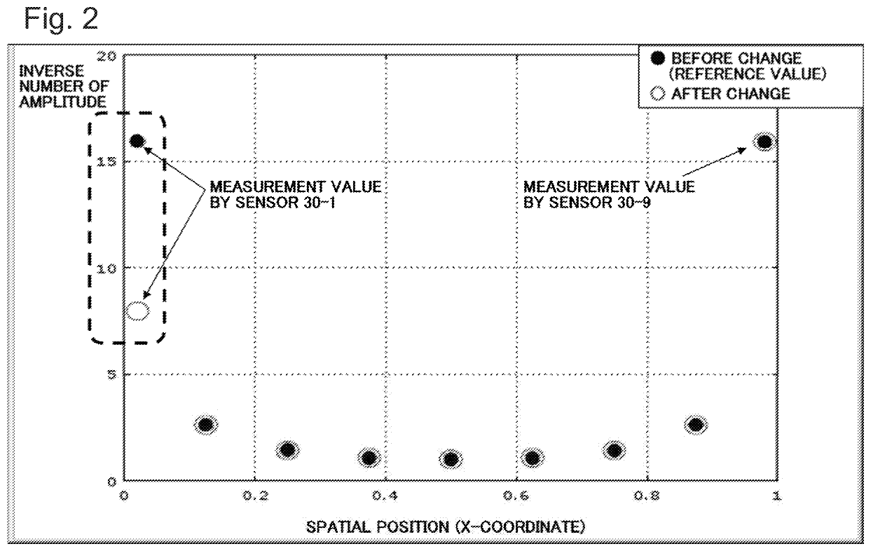

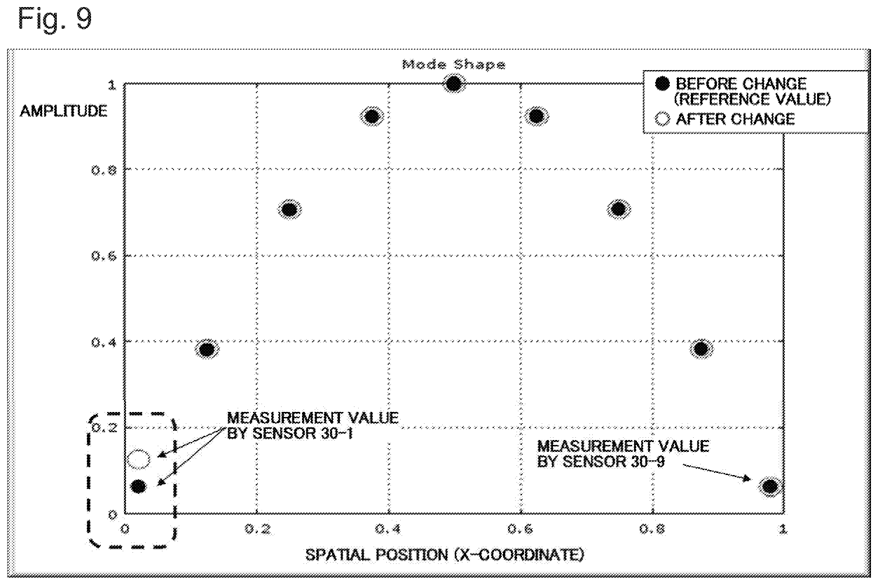

FIG. 2 is a diagram illustrating a change from an inverse number of an amplitude indicated by the inverse-mode-shape reference value 142, relating to an inverse number of an amplitude indicated by an inverse mode shape 112 generated by the generating unit 11 according to the present example embodiment when damage occurs in the vicinity of the support point 210 of the bridge 20. Note that a change from an amplitude indicated by the mode-shape reference value 141 relating to an amplitude indicated by a mode shape 111 generated by the generating unit 11 in this case is as illustrated in FIG. 9 described above. As illustrated in FIGS. 2 and 9, when damage occurs in the vicinity of the support point 210 of the bridge 20, a difference (change amount) of amplitudes between the mode shape 111 and the mode-shape reference value 141 is small, whereas a difference (change amount) of inverse numbers of amplitudes between the inverse mode shape 112 and the inverse-mode-shape reference value 142 becomes great.

After generating the mode-shape reference value 141 and the inverse-mode-shape reference value 142, the generating unit 11 generates the mode shape 111 of the bridge 20 by use of Equation 1, based on the measurement data collected by the sensors 30-1 to 30-9 at a predetermined timing, and generates the inverse mode shape 112 of the bridge 20 by use of Equation 2. The generating unit 11 inputs the generated mode shape 111 and inverse mode shape 112 to the calculating unit 12.

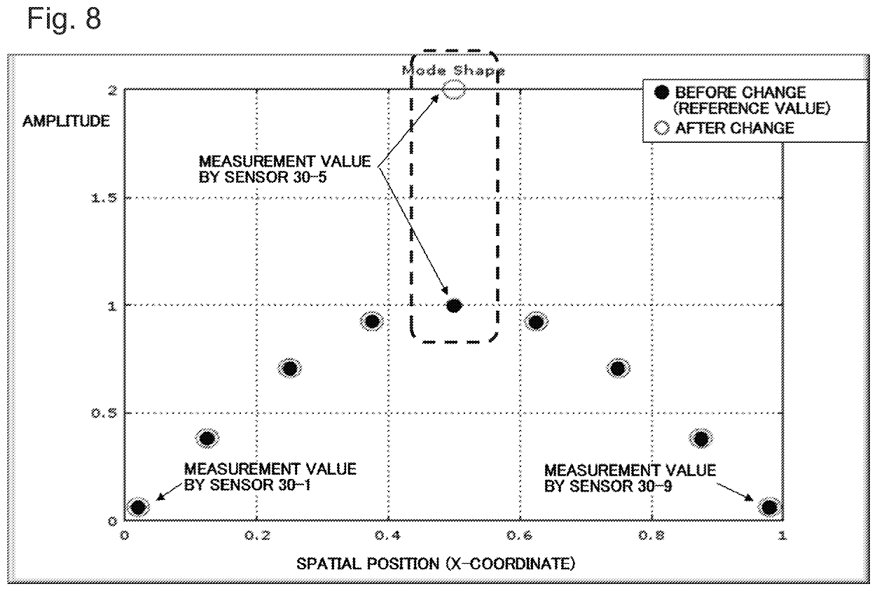

The generating unit 11 may display a graph representing the mode-shape reference value 141 and the mode shape 111 that have been generated, on a display device (not illustrated in FIG. 1) such as a monitor in an overlapping manner, for example, as illustrated in FIG. 8. The generating unit 11 may display a graph representing the inverse-mode-shape reference value 142 and the inverse mode shape 112 that have been generated, on the display device in an overlapping manner, for example, as illustrated in FIG. 2.

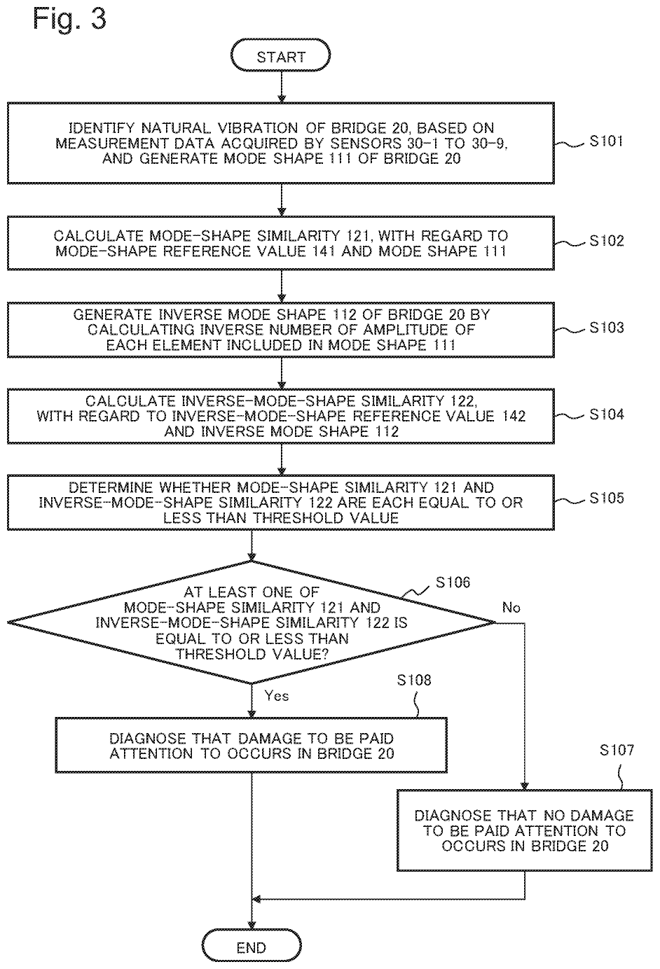

The calculating unit 12 calculates a mode-shape similarity 121, in relation to the mode shape 111 input from the generating unit 11, and the mode-shape reference value 141 stored in the storage unit 14. It is assumed that the calculating unit 12 according to the present example embodiment uses, as an index representing the mode-shape similarity 121, a mode reliability evaluation standard MAC being a well-known index. The calculating unit 12 calculates the MAC as illustrated in FIG. 3.

$$MAC ( F , I ) = \frac{{‖ {Φ}_{F}^{T} {Φ}_{I} ‖}^{2}}{{‖ {Φ}_{F} ‖}^{2} {‖ {Φ}_{I} ‖}^{2}} \qquad ( Equation 3 )$$

In Equation 3, F is a sign representing the mode-shape reference value 141, and I is a sign representing the mode shape 111. Specifically, Φ_{F} is a characteristic vector representing the mode-shape reference value 141, and Φ₁ is a characteristic vector representing the mode shape 111. In Equation 3, T is a sign representing a transposition of a vector, and Φ_{F}^{T} represents a transposed vector of Φ_{F}. “∥Φ_{F}∥²” and “∥Φ_{I}∥²” indicated by a denominator of Equation 3 represent squares of norms (lengths of the vectors) of the characteristic vector Φ_{F} and the characteristic vector Φ_{I}, in order. “∥Φ_{F}^{T}Φ_{I∥}²” indicated by a numerator of Equation 3 represents a square of an inner product of the characteristic vector Φ_{F} and the characteristic vector Φ_{I}. Therefore, MAC(F, I) is an index that approaches “1” as a similarity between the characteristic vector Φ_{F} and the characteristic vector Φ_{I} is greater, and approaches “0” as the similarity is smaller.

The calculating unit 12 calculates an inverse-mode-shape similarity 122, in relation to the inverse mode shape 112 input from the generating unit 11, and the inverse-mode-shape reference value 142 stored in the storage unit 14. In the present example embodiment, MAC′ being calculable similarly to the above-described mode reliability evaluation standard MAC are defined as an index representing the inverse-mode-shape similarity 122. The calculating unit 12 calculates the MAC′ as indicated by Equation 4.

$${MAC}^{′} ( {F}^{- 1} , {I}^{- 1} ) = \frac{{‖ {( {Φ}_{F}^{- 1} )}^{T} ( {Φ}_{I}^{- 1} ) ‖}^{2}}{{‖ {( {Φ}_{F}^{- 1} )}^{T} ‖}^{2} {‖ ( {Φ}_{I}^{- 1} ) ‖}^{2}} \qquad ( Equation 4 )$$

In Equation 4, F is a sign representing the inverse-mode-shape reference value 142, and I is a sign representing the inverse mode shape 112. Specifically, Φ_{F}⁻¹ is a characteristic vector representing the inverse-mode-shape reference value 142, and Φ₁⁻¹ is a characteristic vector representing the inverse mode shape 112. In Equation 4, T is a sign representing a transposition of a vector, and (Φ_{F}⁻¹)^{T} represents a transposed vector of Φ_{F}⁻¹. “∥Φ_{F}⁻¹∥²” and “∥Φ_{I}⁻¹∥²” indicated by a denominator of Equation 4 represent squares of norms of the characteristic vector Φ_{F}⁻¹ and the characteristic vector Φ_{I}⁻¹, in order. “∥(Φ_{F}⁻¹)^{T}(Φ_{I}⁻¹)∥²” indicated by a numerator of Equation 4 represents a square of an inner product of the characteristic vector Φ_{F}⁻¹ and the characteristic vector Φ_{I}⁻¹. Therefore, similarly to MAC indicated in Equation (3), MAC′(F⁻¹, I⁻¹) is an index that approaches “1” as a similarity between the characteristic vector Φ_{F}⁻¹ and the characteristic vector Φ_{I}⁻¹ is greater, and approaches “0” as the similarity is smaller.

The calculating unit 12 inputs, to the diagnosing unit 13, the mode-shape similarity 121 (MAC) and the inverse-mode-shape similarity 122 (MAC′) that have been calculated.

The diagnosing unit 13 diagnoses damage occurring in the bridge 20, based on the mode-shape similarity 121 (MAC) and the inverse-mode-shape similarity 122 (MAC′) that have been input from the calculating unit 12. Specifically, when at least one of a fact that the MAC is equal to or less than a threshold value relating to the MAC and a fact that the MAC′ is equal to or less than a threshold value relating to the MAC′ is satisfied, the diagnosing unit 13 diagnoses that damage to be paid attention to (to be taken care of) occurs in the bridge 20. When the MAC is greater than the threshold value relating to the MAC and the MAC′ is greater than the threshold value relating to the MAC′, the diagnosing unit 13 diagnoses that no damage to be paid attention to occurs in the bridge 20.

Next, an operation (processing) of the damage diagnosing device 10 according to the present example embodiment is described in detail with reference to a flowchart in FIG. 3.

The generating unit 11 identifies natural vibration of the bridge 20, based on the measurement data acquired by the sensors 30-1 to 30-9, and generates the mode shape 111 of the bridge 20 (step S101). The calculating unit 12 calculates the mode-shape similarity 121, with regard to the mode-shape reference value 141 stored in the storage unit 14, and the mode shape 111 generated by the generating unit 11 (step S102).

The generating unit 11 generates the inverse mode shape 112 of the bridge 20 by calculating an inverse number of an amplitude of each element included in the mode shape 111 (step S103). The calculating unit 12 calculates the inverse-mode-shape similarity 122, with regard to the inverse-mode-shape reference value 142 stored in the storage unit 14, and the inverse mode shape 112 generated by the generating unit 11 (step S104). The diagnosing unit 13 determines whether the mode-shape similarity 121 and the inverse-mode-shape similarity 122 are each equal to or less than the threshold value (step S 105). When the mode-shape similarity 121 and the inverse-mode-shape similarity 122 are more than the threshold value (No in step S 106), the diagnosing unit 13 diagnoses that no damage to be paid attention to occurs in the bridge 20 (step S 107), and the overall processing ends. When at least one of the mode-shape similarity 121 and the inverse-mode-shape similarity 122 is equal to or less than the threshold value (Yes in step S 106), the diagnosing unit 13 diagnoses that damage to be paid attention to occurs in the bridge 20 (step S 108), and the overall processing ends.

The damage diagnosing device 10 according to the present example embodiment can more accurately diagnose damage occurring in a structure, such as a bridge, including a supporting portion and a supported portion supported at a support point by the supporting portion. A reason for this is that the damage diagnosing device 10 generates the inverse mode shape 112 (second vibration characteristic information) including a characteristic value having an increase characteristic opposite to an amplitude indicated by the mode shape 111 (first vibration characteristic information) relating to the bridge 20, and diagnoses damage occurring in the bridge 20, based on a degree that the mode shape 111 and the inverse mode shape 112 change from reference values thereof as a result of damage occurring in the bridge 20.

An advantageous effect achieved by the damage diagnosing device 10 according to the present example embodiment is described below in detail.

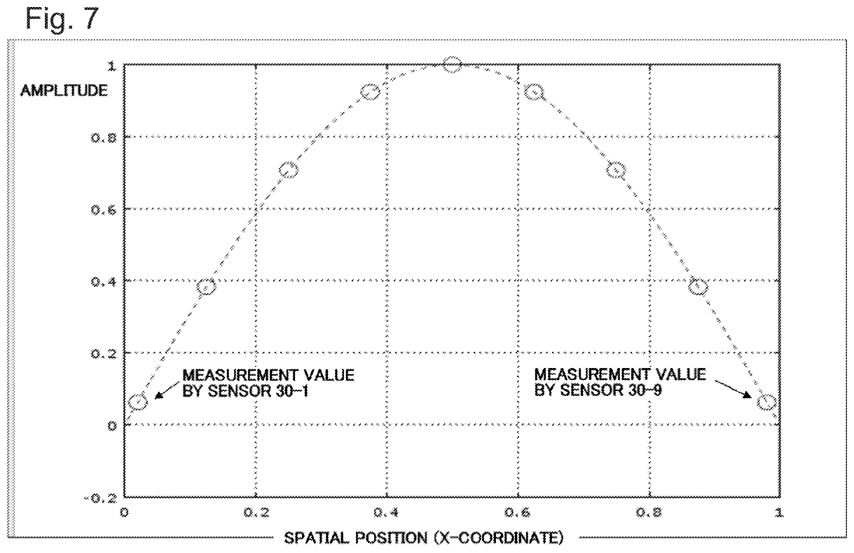

It is known that an amplitude characteristic indicated by a mode shape of a structure, such as the bridge 20, including the supporting portion 21 or 22 and the supported portion 23 supported at the support point 210 or 220 by the supporting portion generally becomes small in amplitude in the vicinity of a support point (a position equivalent to a node) or the like, and becomes great in amplitude in the vicinity of a middle part between two support points (a position equivalent to an antinode), as illustrated in FIG. 7. When diagnosing damage occurring in the bridge 20 by detecting a change in a mode shape of the bridge 20 due to the damage, diagnosis of damage is easy because a change amount of a mode shape is great, in relation to damage occurring in the vicinity of a middle part in the supported portion 23 of the bridge 20 as illustrated in FIG. 8. In contrast, in relation to damage occurring in the vicinity of the support point 210 of the bridge 20 as illustrated in FIG. 9, a change amount of a mode shape is small, and damage needs to be diagnosed with the change amount of a certain level in order to avoid erroneous determination resulting from an error, noise, or the like. In consideration of this, there is fear that occurrence of damage is overlooked. Specifically, even when damage occurs in the vicinity of a support point where an amplitude indicated by a mode shape is small in a structure such as a bridge, accurately diagnosing the damage occurring in the structure is a problem.

For such a problem, the damage diagnosing device 10 according to the present example embodiment includes the generating unit 11, the calculating unit 12, and the diagnosing unit 13, and operates, for example, as described above with reference to FIGS. 1 to 3. Specifically, the generating unit 11 generates second vibration characteristic information (the inverse mode shape 112) including a characteristic value (i.e., an inverse number of an amplitude) having an increase characteristic opposite to an amplitude indicated by first vibration characteristic information (the mode shape 111) relating to a structure (the bridge 20) including the supporting portions 21 and 22, and the supported portion 23 supported at the support points 210 and 220 by the supporting portions. The calculating unit 12 calculates a degree that values indicated by the first and second vibration characteristic information change from reference values (the mode-shape reference value 141 and the inverse-mode-shape reference value 142) relating to the first and second vibration characteristic information as a result of damage occurring in the structure. Then, the diagnosing unit 13 diagnoses the damage, based on the degree of change.

More specifically, the damage diagnosing device 10 according to the present example embodiment diagnoses that damage to be paid attention to occurs in the bridge 20, by use of two indices being the mode shape 111 and the inverse mode shape 112 having increase characteristics relating to amplitudes opposite to each other, when at least one of degrees of change from each of reference values relating to the mode shape 111 and the inverse mode shape 112 (similarities to the reference values) satisfies a reference. Specifically, the damage diagnosing device 10 performs a diagnosis based on the mode shape 111, with regard to damage occurring in a place (the vicinity of a middle part between two support points or the like) where the degree of change relating to the mode shape 111 is greater than that relating to the inverse mode shape 112. The damage diagnosing device 10 performs a diagnosis based on the inverse mode shape 112, with regard to damage occurring in a place (the vicinity of two support points or the like) where the degree of change relating to the inverse mode shape 112 is greater than that relating to the mode shape 111. Thus, the damage diagnosing device 10 according to the present example embodiment can more accurately diagnose damage occurring in a structure, such as a bridge, including a supporting portion and a supported portion supported at a support point by the supporting portion.

Although the damage diagnosing device 10 according to the present example embodiment generates the inverse mode shape 112 as an index in which an amplitude indicated by the mode shape 111 is replaced by an inverse number thereof, a characteristic value included in the inverse mode shape 112 is not limited to an inverse number of an amplitude indicated by the mode shape 111. A characteristic value included in the inverse mode shape 112 may have an increase characteristic (a characteristic that becomes greater as an amplitude indicated by the mode shape 111 becomes smaller) opposite to an amplitude indicated by the mode shape 111.

The damage diagnosing device 10 according to the present example embodiment may use, as vibration characteristic information relating to the bridge 20, information different from a mode shape. The damage diagnosing device 10 may diagnose damage occurring in the bridge 20, by use of an evaluation value different from an evaluation value based on a similarity relating to a mode shape such as MAC. For example, in relation to two pieces of vibration characteristic information having increase characteristics relating to amplitudes opposite to each other, the damage diagnosing device 10 may diagnose damage occurring in the bridge 20, based on a change amount (difference) from reference values relating to the two pieces of vibration characteristic information.

Note that a structure targeted for diagnosing damage by the damage diagnosing device 10 according to the present example embodiment is not limited to a bridge. The structure may include a supporting portion and a supported portion supported at a support point by the supporting portion. Therefore, the damage diagnosing device 10 according to the present example embodiment may target, for diagnosing damage, for example, a building, a chimney, an architectural structure such as a plant, a signboard, or the like.

### Second Example Embodiment

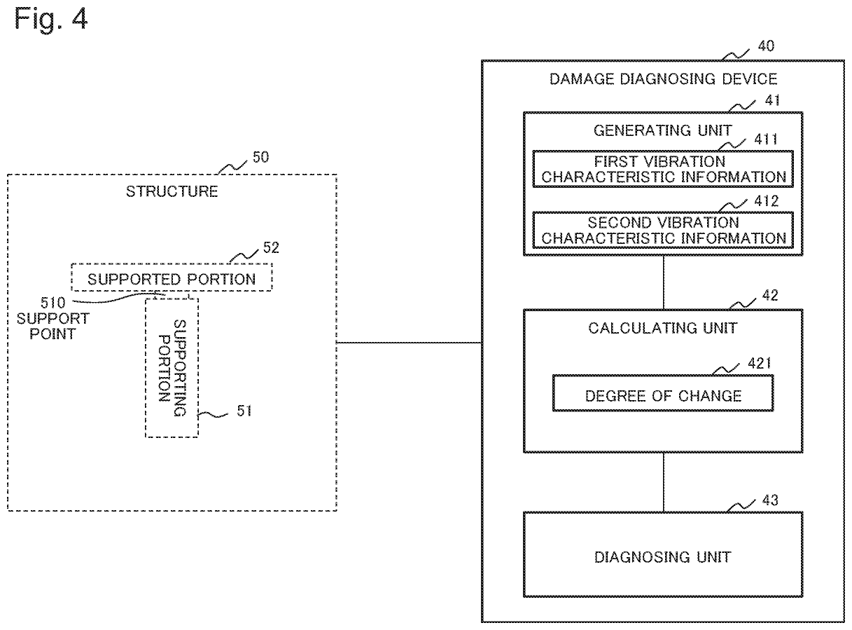

FIG. 4 is a block diagram conceptually illustrating a configuration of a damage diagnosing device 40 according to a second example embodiment of the invention of the present application.

The damage diagnosing device 40 according to the present example embodiment includes a generating unit 41, a calculating unit 42, and a diagnosing unit 43.

The generating unit 41 generates second vibration characteristic information 412 including a characteristic value having an increase characteristic opposite to an amplitude indicated by first vibration characteristic information 411 relating to a structure 50, including a supporting portion 51 and a supported portion 52 supported at a support point 510 by the supporting portion 51.

The calculating unit 42 calculates a degree 421 to which values indicated by the first vibration characteristic information 411 and the second vibration characteristic information 412 change from reference values relating to the first vibration characteristic information 411 and the second vibration characteristic information 412 as a result of damage occurring in the structure 50.

The diagnosing unit 43 diagnoses the damage, based on the degree 421 of change.

The damage diagnosing device 40 according to the present example embodiment can more accurately diagnose damage occurring in the structure 50 including the supporting portion 51, and the supported portion 52 supported at the support point 510 by the supporting portion 51. A reason for this is that the damage diagnosing device 10 generates the second vibration characteristic information 412 including a characteristic value having an increase characteristic opposite to an amplitude indicated by the first vibration characteristic information 411 relating to the structure 50, and diagnoses damage occurring in the structure 50, based on a degree that the first vibration characteristic information 411 and the second vibration characteristic information 412 change from reference values thereof as a result of damage occurring in the structure 50.

<Hardware Configuration Example>

Each unit in each of the damage diagnosing devices illustrated in FIGS. 1 and 4 in each of the example embodiments described above can be achieved by dedicated hardware (HW) (electronic circuit). In FIGS. 1 and 4, at least the following configuration can be considered as a functional (processing) unit (software module) of a software program.
Generating units 11 and 41,
calculating units 12 and 42, and
diagnosing units 13 and 43.

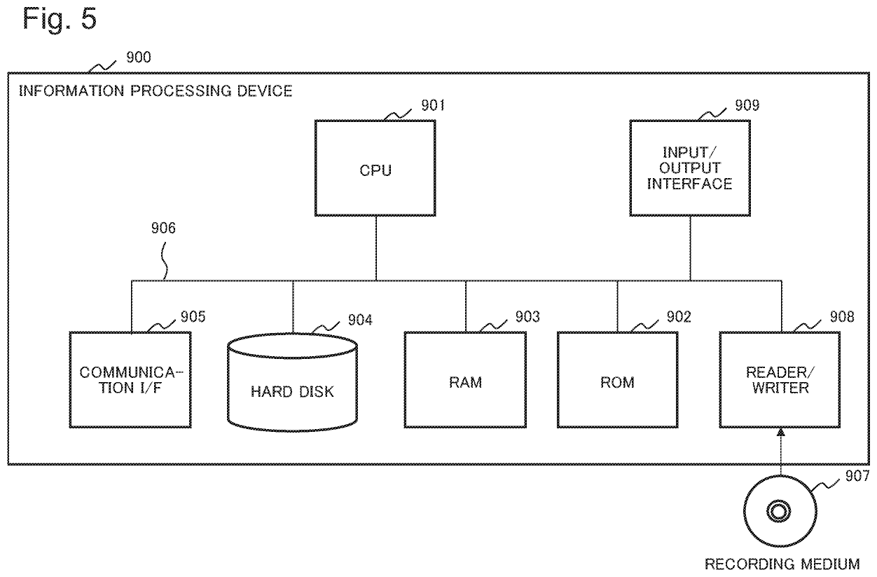

Note, however, that classification of each unit illustrated in the drawings is a configuration serving for convenience of description, and various configurations are conceivable during implementation. One example of a hardware environment in this case is described with reference to FIG. 5.

FIG. 5 is a diagram exemplarily describing a configuration of an information processing device 900 (computer) being capable of executing the damage diagnosing device according to each example embodiment of the invention of the present application. Specifically, FIG. 5 represents a hardware environment being a configuration of a computer (information processing device) capable of achieving the damage diagnosing devices 10 and 40 illustrated in FIGS. 1 and 4, and being capable of achieving each function in the example embodiments described above.

The information processing device 900 illustrated in FIG. 5 includes the following as components.
A central processing unit (CPU) 901,
a read only memory (ROM) 902,
a random access memory (RAM) 903,
a hard disk (storage device) 904,
a communication interface 905 with an external device,
a bus 906 (communication wire),
a reader/writer 908 capable of reading and writing data stored in a recording medium 907 such as a compact disc read only memory (CD-ROM), and
an input/output interface 909.

Specifically, the information processing device 900 including the components described above is a general computer to which these components are connected via the bus 906. The information processing device 900 may include a plurality of CPUs 901, or include a multicore CPU 901.

Furthermore, the invention of the present application described with the above-described example embodiments as examples supplies the information processing device 900 illustrated in FIG. 5 with a computer program capable of achieving the following function. The function is a function of the above-described configuration in the block configuration diagrams (FIGS. 1 and 4) referred to in the description of the example embodiments, or the flowchart (FIG. 3). Thereafter, the invention of the present application is accomplished by reading the computer program in the CPU 901 of the hardware, and then interpreting and executing the computer program. The computer program supplied into the device may be stored in a readable/writable volatile memory (the RAM 903), or a non-volatile storage device such as the ROM 902 or the hard disk 904.

In the above-described case, a general procedure can be adopted at present as a method of supplying a computer program into the hardware. As the procedure, there is, for example, a method that installs into the device via various recording media 907 such as a CD-ROM, a method that downloads from outside via a communication line such as the Internet, or the like. In such a case, it can be considered that the invention of the present application is configured by a code constituting the computer program, or the recording medium 907 storing the code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Note that some or all of the above-described example embodiments may be also described as in the following supplementary notes. However, the invention of the present application exemplarily described with each of the above-described example embodiments is not limited to the following.

(Supplementary Note 1)

A damage diagnosing device including:

a generating means for generating second vibration characteristic information including a characteristic value having an increase characteristic opposite to an amplitude indicated by first vibration characteristic information, relating to a structure including a supporting portion and a supported portion supported at a support point by the supporting portion;

a calculating means for calculating a degree that values indicated by the first and second vibration characteristic information change from reference values relating to the first and second vibration characteristic information as a result of damage occurring in the structure; and a diagnosing means for diagnosing the damage, based on the degree of change.

(Supplementary Note 2)

The damage diagnosing device according to Supplementary Note 1, wherein

the generating means calculates, as the characteristic value, an inverse number of the amplitude indicated by the first vibration characteristic information.

(Supplementary Note 3)

The damage diagnosing device according to Supplementary Note 1 or 2, wherein

the first and second vibration characteristic information represent a characteristic vector including values representing an amplitude and a phase relating to vibration, for each of one or more observation points in the structure.

(Supplementary Note 4)

The damage diagnosing device according to Supplementary Note 3, wherein

the calculating means calculates a similarity indicating the degree of change, based on a norm of the characteristic vector relating to the first or second vibration characteristic information, a norm of the characteristic vector relating to the reference value relating to the first or second vibration characteristic information, and a value representing an inner product of the characteristic vector relating to the first or second vibration characteristic information and the characteristic vector relating to the reference value relating to the first or second vibration characteristic information.

(Supplementary Note 5)

The damage diagnosing device according to Supplementary Note 4, wherein

the calculating means calculates model assurance criteria (MAC) representing the similarity, based on a mode shape representing the characteristic vector.

(Supplementary Note 6)

The damage diagnosing device according to Supplementary Note 4 or 5, wherein

the diagnosing means determines whether the similarity is equal to or less than a threshold value.

(Supplementary Note 7)

The damage diagnosing device according to Supplementary Note 6, wherein

the structure is a bridge.

(Supplementary Note 8)

The damage diagnosing device according to any one of Supplementary Notes 1 to 7, wherein

the generating means displays the first vibration characteristic information being generated and the reference value relating to the first vibration characteristic information on a display device in an overlapping manner, and displays the second vibration characteristic information being generated and the reference value relating to the second vibration characteristic information on the display device in an overlapping manner.

(Supplementary Note 9)

A damage diagnosing system including:

the damage diagnosing device according to any one of Supplementary Notes 1 to 8; and

a sensor that collects, from the structure, information needed for the generating means to generate the first and second vibration characteristic information.

(Supplementary Note 10)

A damage diagnosing method including:

by an information processing device,
generating second vibration characteristic information including a characteristic value having an increase characteristic opposite to an amplitude indicated by first vibration characteristic information, relating to a structure including a supporting portion and a supported portion supported at a support point by the supporting portion;
calculating a degree that values indicated by the first and second vibration characteristic information change from reference values relating to the first and second vibration characteristic information as a result of damage occurring in the structure; and
diagnosing the damage, based on the degree of change.

(Supplementary Note 11)

A recording medium storing a damage diagnosing program for causing a computer to execute:

generating processing of generating second vibration characteristic information including a characteristic value having an increase characteristic opposite to an amplitude indicated by first vibration characteristic information, relating to a structure including a supporting portion and a supported portion supported at a support point by the supporting portion;

calculating processing of calculating a degree that values indicated by the first and second vibration characteristic information change from reference values relating to the first and second vibration characteristic information as a result of damage occurring in the structure; and

determining processing of diagnosing the damage, based on the degree of change.

This application is based upon and claims the benefit of priority from Japanese Patent Application No. 2017-220893, filed on Nov. 16, 2017, the disclosure of which is incorporated herein in its entirety by reference.

### REFERENCE SIGNS LIST

1 Damage diagnosing system
10 Damage diagnosing device
11 Generating unit
111 Mode shape
112 Inverse mode shape
12 Calculating unit
121 Mode-shape similarity
122 Inverse-mode-shape similarity
13 Diagnosing unit
14 Storage unit
141 Mode-shape reference value
142 Inverse-mode-shape reference value
15 Communication unit
20 Bridge
21 Supporting portion
210 Support point
22 Supporting portion
220 Support point
23 Supported portion
30-1 to 30-9 Sensor
31 Measurement data aggregator
40 Damage diagnosing device
41 Generating unit
411 First vibration characteristic information
412 Second vibration characteristic information
42 Calculating unit
421 Degree of change
43 Diagnosing unit
50 Structure
51 Supporting portion
52 Supported portion
510 Support point
900 Information processing device
901 CPU
902 ROM
903 RAM
904 Hard disk
905 Communication interface
906 Bus 907 Recording medium 908 Reader/writer 909 Input/output interface

1. A damage diagnosing device comprising:
at least one memory storing a computer program; and
at least one processor configured to execute the computer program to:
generate second vibration characteristic information including a characteristic value having an increase characteristic opposite to an amplitude indicated by first vibration characteristic information, relating to a structure including a supporting portion and a supported portion supported at a support point by the supporting portion;
calculate a degree that values indicated by the first and second vibration characteristic information change from reference values relating to the first and second vibration characteristic information as a result of damage occurring in the structure; and
diagnose the damage, based on the degree of change.)

2. The damage diagnosing device according to claim 1, wherein the processor is configured to execute the computer program to
calculate, as the characteristic value, an inverse number of the amplitude indicated by the first vibration characteristic information.

3. The damage diagnosing device according to claim 1 wherein
the first and second vibration characteristic information represent a characteristic vector including values representing an amplitude and a phase relating to vibration, for each of one or more observation points in the structure.

4. The damage diagnosing device according to claim 3, wherein the processor is configured to execute the computer program to
calculate a similarity indicating the degree of change, based on a norm of the characteristic vector relating to the first or second vibration characteristic information, a norm of the characteristic vector relating to the reference value relating to the first or second vibration characteristic information, and a value representing an inner product of the characteristic vector relating to the first or second vibration characteristic information and the characteristic vector relating to the reference value relating to the first or second vibration characteristic information.

5. The damage diagnosing device according to claim 4, wherein the processor is configured to execute the computer program to
calculate model assurance criteria (MAC) representing the similarity, based on a mode shape representing the characteristic vector.

6. The damage diagnosing device according to claim 4, wherein the processor is configured to execute the computer program to
determine whether the similarity is equal to or less than a threshold value.

7. The damage diagnosing device according to claim 6, wherein
the structure is a bridge.

8. The damage diagnosing device according to claim 1, wherein the processor is configured to execute the computer program to:
display the first vibration characteristic information being generated and the reference value relating to the first vibration characteristic information on a display device in an overlapping manner, and
display the second vibration characteristic information being generated and the reference value relating to the second vibration characteristic information on the display device in an overlapping manner.

9. (canceled)

10. A damage diagnosing method comprising:
by an information processing device,
generating second vibration characteristic information including a characteristic value having an increase characteristic opposite to an amplitude indicated by first vibration characteristic information, relating to a structure including a supporting portion and a supported portion supported at a support point by the supporting portion;
calculating a degree that values indicated by the first and second vibration characteristic information change from reference values relating to the first and second vibration characteristic information as a result of damage occurring in the structure; and
diagnosing the damage, based on the degree of change.

11. A non-transitory computer-readable recording medium storing a damage diagnosing program for causing a computer to execute:
generating processing of generating second vibration characteristic information including a characteristic value having an increase characteristic opposite to an amplitude indicated by first vibration characteristic information, relating to a structure including a supporting portion and a supported portion supported at a support point by the supporting portion;
calculating processing of calculating a degree that values indicated by the first and second vibration characteristic information change from reference values relating to the first and second vibration characteristic information as a result of damage occurring in the structure; and
determining processing of diagnosing the damage, based on the degree of change.
